(19) United States
(12) Patent Application Publication
(10) Pub. No.: US 2024/0092279 A1
(43) Pub. Date: Mar. 21, 2024

(54) ELECTROLUMINESCENT VEHICLE ORNAMENT

(71) Applicant: Kishore Musale, Burjuman (AE)

(72) Inventor: Kishore Musale, Burjuman (AE)

(21) Appl. No.: 17/949,537

(22) Filed: Sep. 21, 2022

(51) Int. Cl. B60R 13/00; H05B 33/12

(52) U.S. Cl. CPC B60R 13/005; H05B 33/12

(57) ABSTRACT

Disclosed embodiments provide electroluminescent vehicle ornaments. The vehicle ornaments are backlit with an electroluminescence device installed within a housing. The housing includes a translucent portion that is aligned with the electroluminescence device, enabling light to pass therethrough. In some embodiments, the translucent portion may comprise translucent chrome, and/or a colored film, to create a specific appearance. Some embodiments may include a factory-installed vehicle ornament that is installed by the vehicle manufacturer at the time of the vehicle assembly. Some embodiments may include aftermarket vehicle ornaments that are installed by third-party repair facilities and/or end-users. Some embodiments may include advanced illumination features such as changes in illumination as a function of vehicle operating parameters. Some embodiments obtain power from the vehicle power supply. Other embodiments may utilize a self-contained power source.

### FIELD

The present invention relates generally to vehicle ornaments, and more particularly, to an electroluminescent vehicle ornament.

### BACKGROUND

Creating a strong brand identity in the vehicle industry involves creativity and attention to detail. Vehicles such as automobiles, trucks, and motorcycles are often recognized by a badge, insignia, ornament, and/or other cosmetic artifacts. An attention-getting ornament can help promote brand-awareness for a vehicle.

Vehicle ornaments are often installed during manufacture in the factory. Additionally, vehicle ornaments can be installed post-manufacture, in an automobile dealership, third-party shop, and/or by end-users. Vehicle customization is a multi-million-dollar industry. Vehicle customization can include modification of vehicles to boost their performance. Additionally, vehicle modification can also include changes to the vehicle's overall appearance. These aesthetic modifications can include customized vehicle ornaments. Automobile enthusiasts often like to modify and accessorize their vehicles in order to give them a unique appearance.

### SUMMARY

In one embodiment, there is provided an electroluminescent vehicle ornament, comprising: an electroluminescence device, the device comprising: a transparent conductive-coated substrate; a first electrode disposed on a first portion of the transparent conductive-coated substrate; an electroluminescent layer disposed on a second portion of the transparent conductive-coated substrate; a reflecting dielectric layer disposed on the electroluminescent layer; a second electrode disposed on the reflecting dielectric layer; and a housing, wherein the housing is configured and disposed to contain the electroluminescence device, and wherein the housing comprises a translucent portion that is aligned with the electroluminescence device.

In another embodiment, there is provided an electroluminescent vehicle ornament, comprising: an electroluminescence device, the device comprising: a transparent conductive-coated substrate; a first electrode disposed on a first portion of the transparent conductive-coated substrate; an electroluminescent layer disposed on a second portion of the transparent conductive-coated substrate; a reflecting dielectric layer disposed on the electroluminescent layer; a second electrode disposed on the reflecting dielectric layer; and a rechargeable battery; a charging port, coupled to the rechargeable battery; an alternating current (AC) inverter, configured and disposed to receive direct current from the rechargeable battery, and output alternating current to the electroluminescence device; a housing, the housing configured and disposed to contain the electroluminescence device, and the rechargeable battery, and wherein the housing comprises a translucent portion that is aligned with the electroluminescence device.

In yet another embodiment, there is provided an electroluminescent vehicle ornament, comprising: an electroluminescence device, the device comprising: a transparent conductive-coated substrate; a first electrode disposed on a first portion of the transparent conductive-coated substrate; an electroluminescent layer disposed on a second portion of the transparent conductive-coated substrate; a reflecting dielectric layer disposed on the electroluminescent layer; a second electrode disposed on the reflecting dielectric layer; and a rechargeable battery; a charging port, coupled to the rechargeable battery; an alternating current (AC) inverter, configured and disposed to receive direct current from the rechargeable battery, and output alternating current to the electroluminescence device; a processor; a memory coupled to the processor; an ambient light sensor coupled to the processor; a housing, the housing configured and disposed to contain the electroluminescence device, processor, memory, ambient light sensor, and the rechargeable battery, and wherein the housing comprises a translucent portion that is aligned with the electroluminescence device.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting.

Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

Often, similar elements may be referred to by similar numbers in various figures (FIGs) of the drawing, in which case typically the last two significant digits may be the same, the most significant digit being the number of the drawing figure (FIG). Furthermore, for clarity, some reference numbers may be omitted in certain drawings.

FIG. 1 shows an electroluminescence device for embodiments of the present invention.

FIG. 2A shows an electroluminescent vehicle ornament in accordance with embodiments of the present invention.

FIG. 2B shows an electroluminescent vehicle ornament in accordance with additional embodiments of the present invention.

FIG. 3A shows an example of a self-contained electroluminescent vehicle ornament in accordance with embodiments of the present invention during the installation process.

FIG. 3B shows an example of a self-contained electroluminescent vehicle ornament in accordance with embodiments of the present invention in an installed configuration.

FIG. 3C shows an example of a self-contained electroluminescent vehicle ornament in accordance with embodiments of the present invention in a recharging configuration.

FIG. 4A shows an example of a front view of an electroluminescent vehicle ornament in accordance with embodiments of the present invention.

FIG. 4B shows a side view of the electroluminescent vehicle ornament of FIG. 4A.

FIG. 4C shows a top-down view of the electroluminescent vehicle ornament of FIG. 4A.

FIG. 5 shows an example of the electroluminescent vehicle ornament of FIG. 4A installed on a vehicle.

FIG. 6 is a block diagram showing components of disclosed embodiments.

FIG. 7 is a flowchart indicating process steps for embodiments of the present invention.

FIG. 8 shows an electroluminescent response for embodiments of the present invention.

FIG. 9 shows an example of a self-contained electroluminescent vehicle ornament in accordance with another embodiment of the present invention.

### DETAILED DESCRIPTION

Disclosed embodiments provide electroluminescent vehicle ornaments. The vehicle ornaments are backlit with an electroluminescence device installed within a housing. The housing includes a translucent portion that is aligned with the electroluminescence device, enabling light to pass therethrough. In some embodiments, the translucent portion may comprise translucent chrome, and/or a colored film, to create a specific appearance. Some embodiments may include a factory-installed vehicle ornament that is installed by the vehicle manufacturer at the time of the vehicle assembly. Some embodiments may include aftermarket vehicle ornaments that are installed by third-party repair facilities and/or end-users. Some embodiments may include advanced illumination features such as changes in illumination as a function of vehicle operating parameters. Some embodiments obtain power from the vehicle power supply. Other embodiments may utilize a self-contained power source.

As used herein, “translucent” refers to a material or layer that is not completely opaque, and which allows at least some light to be transmitted therethrough, and includes transparent and translucent materials that can be colored or colorless.

Disclosed embodiments utilize an electroluminescence device. The electroluminescence device can include a flexible electroluminescence cell that is activated by an alternating electrical current. The flexible electroluminescence cell can be fabricated in most any shape, and provide an evenly distributed light source, making it well-suited for vehicle ornaments. Disclosed embodiments may utilize an electroluminescence cell such as that disclosed in U.S. Pat. No. 7,148,623 to Vlaskin, et al, dated Dec. 12, 2006, and U.S. Pat. No. 5,912,533 to Lee, et al., dated Jun. 15, 1999, both of which are incorporated herein by reference in their entirety.

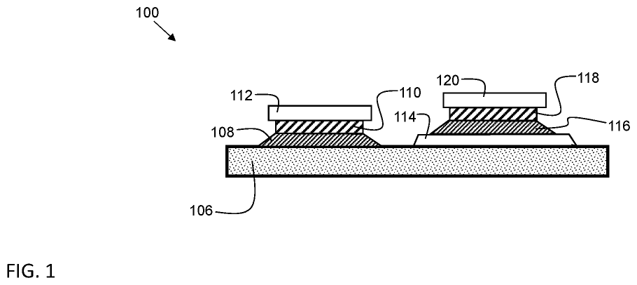

FIG. 1 shows an electroluminescence device 100 for embodiments of the present invention. Electroluminescence device 100 includes a transparent conductive-coated substrate 106. The substrate 106 can include glass, plastic, polycarbonate, etc., with a transparent conductive coating applied thereon (not shown). The conductive coating can include Indium-Tin-Oxide (ITO), Aluminum-Zinc-Oxide (AZO), graphene flakes, and/or other suitable conductive coatings. The conductive coating may be deposited on the substrate 106 via chemical vapor deposition, sputtering, pulsed laser deposition, or other suitable technique.

A first electrode 108 is disposed on the transparent conductive-coated substrate 106. The first electrode may be comprised of copper, aluminum, gold, or other suitable conductor. A layer of conductive adhesive 110 is disposed on first electrode 108. The conductive adhesive may comprise an epoxy infused with a conductive metal such as silver, gold, nickel, and/or copper. A first electrode tab connector 112 is disposed on the conductive adhesive layer 110. The tab connector 112 may comprise copper, gold, aluminum, or other suitable conductive material.

An electroluminescent dielectric layer 114 is disposed on the transparent conductive-coated substrate 106. In embodiments, the electroluminescent dielectric layer 114 can comprise mixture of phosphor powder, one or more binders, and one or more additional elements to create a light of a desired color. For example, by adding Sm to ZnS, or by adding Cu, Mn and Cl to ZnS, red is obtained; by adding Tb to ZnS, or by adding Cu and Cl to ZnS, green is obtained. By adding Tm to ZnS or by adding Cu and Cl to ZnS, blue is obtained. By making a layer with a mixture of materials related to the three colors, white light can be obtained. By using color filters on the white phosphor layer, it is possible to obtain various kinds of colored light.

A second electrode 116 is disposed on the electroluminescent dielectric layer 114. The second electrode may be comprised of copper, aluminum, gold, or other suitable conductor. A layer of conductive adhesive 118 is disposed on second electrode 116. The conductive adhesive may comprise an epoxy infused with a conductive metal such as silver, gold, nickel, and/or copper. A second electrode tab connector 120 is disposed on the conductive adhesive layer 118. The tab connector 120 may comprise copper, gold, aluminum, or other suitable conductive material. In embodiments, wires may be soldered to the tab connectors 112 and 120 that lead to a crimped terminal connector, which can be connected to an alternating current (AC) power source, such as an inverter to power the electroluminescence device 100. In some embodiments, an encapsulating dielectric may be deposited over the electroluminescence device 100 to hermetically seal it and provide additional protection from moisture and other environmental factors.

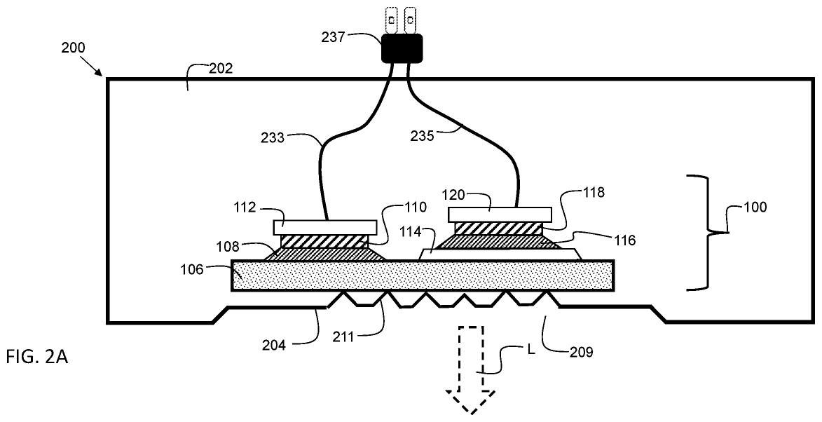

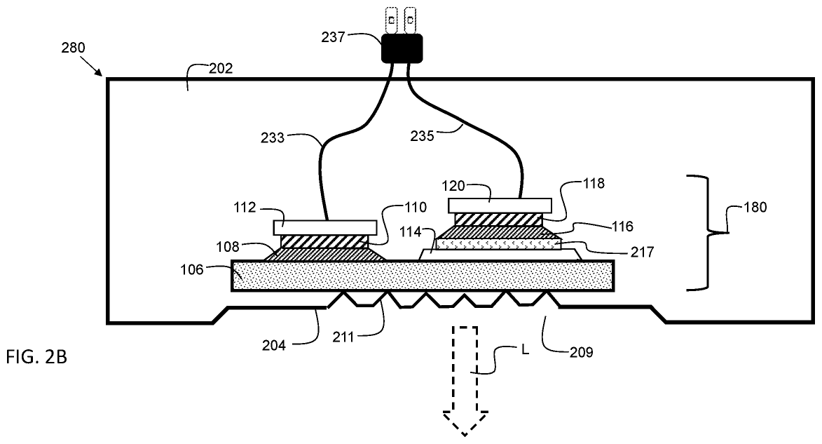

FIG. 2A shows an electroluminescent vehicle ornament 200 in accordance with embodiments of the present invention. The electroluminescent vehicle ornament 200 includes electroluminescence device 100 as described and shown in FIG. 1. The electroluminescence device 100 is enclosed in housing 202. In embodiments, housing 202 may be comprised of a plastic such as polycarbonate, or the like. The housing 202 includes a translucent portion 204. The translucent portion 204 allows light L, that is generated by the electroluminescent dielectric layer 114 to pass therethrough. In embodiments, the translucent portion 204 may be coated in translucent chrome. During daylight conditions, the translucent chrome may appear similar to non-translucent chrome. In darker conditions such as twilight or night, the backlighting of the electroluminescence device 100 can provide an interesting visual effect in which the translucent portion 204 appears to glow.

In some embodiments, a pattern 209 may be formed in the translucent portion. The pattern 209 can include a plurality of triangular grooves, indicated generally at 211. The pattern 209 can disperse light to create an optical effect, as well as create a cosmetic effect even when the backlit illumination is not present.

A first wire 233 is connected to tab connector 112. A second wire 235 is connected to tab connector 120. The first wire 233 and second wire 235 are connected to a crimped connector plug 237. The plug 237 can be connected to an AC power source for activating the electroluminescence device 100. The AC power source can include an AC inverter that is connected to the direct current (DC) power supply of a vehicle.

FIG. 2B shows an electroluminescent vehicle ornament 280 in accordance with additional embodiments of the present invention. The electroluminescent vehicle ornament 280 includes electroluminescence device 180, which is similar to electroluminescence device 100 as described and shown in FIG. 1, with the addition of a reflective dielectric layer 217. The reflective dielectric layer 217 can comprise silicon dioxide, titanium dioxide, and/or other suitable materials. The reflective dielectric layer can increase the light output from the electroluminescent vehicle ornament 280 by reflecting light from the electroluminescent dielectric layer 114.

The electroluminescence device 180 is enclosed in housing 202. In embodiments, housing 202 may be comprised of a plastic such as polycarbonate, or the like. The housing 202 includes a translucent portion 204. The translucent portion 204 allows light L, that is generated by the electroluminescent dielectric layer 114 to pass therethrough. In embodiments, the translucent portion 204 may be coated in translucent chrome. During daylight conditions, the translucent chrome may appear similar to non-translucent chrome. In darker conditions such as twilight or night, the backlighting of the electroluminescence device 180 can provide an interesting visual effect in which the translucent portion 204 appears to glow.

In some embodiments, a pattern 209 may be formed in the translucent portion. The pattern 209 can include a plurality of triangular grooves, indicated generally at 211. The pattern 209 can disperse light to create an optical effect, as well as create a cosmetic effect even when the backlit illumination is not present.

A first wire 233 is connected to tab connector 112. A second wire 235 is connected to tab connector 120. The first wire 233 and second wire 235 are connected to a crimped connector plug 237. In embodiments, wires 233 and 235 may be connected to their respective tab connectors 112 and 120 via solder, screw terminals, or other suitable mechanism. The plug 237 can be connected to an AC power source for activating the electroluminescence device 100. The AC power source can include an AC inverter that is connected to the direct current (DC) power supply of a vehicle.

In embodiments, the housing comprises a translucent portion that is aligned with the electroluminescence device. In embodiments, the translucent portion of the housing comprises translucent chrome. Embodiments can include a plurality of triangular grooves formed in the translucent portion. In embodiments the reflecting dielectric layer comprises silicon dioxide. In embodiments the reflecting dielectric layer comprises titanium dioxide.

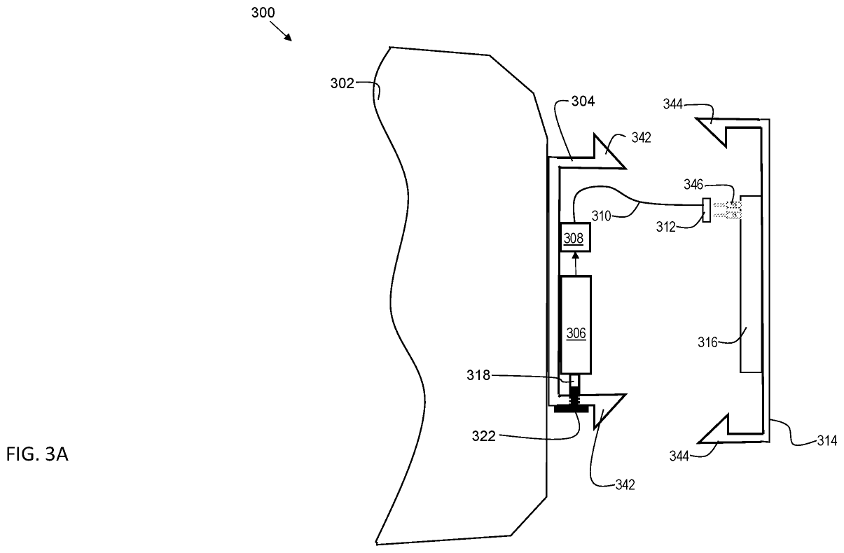

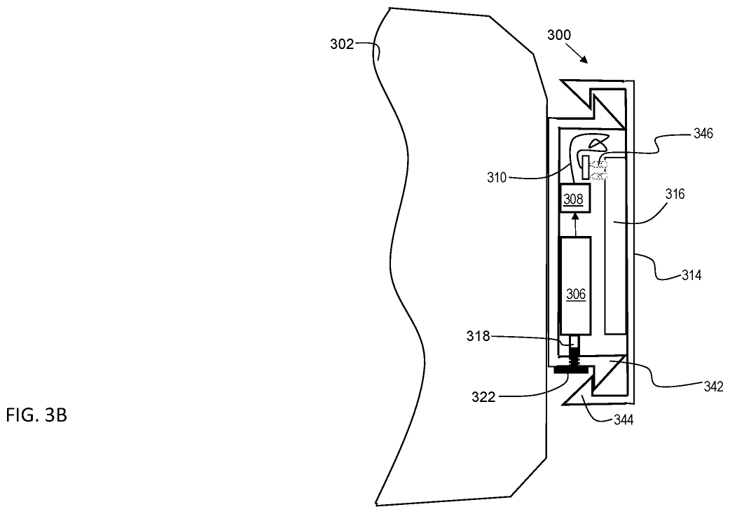

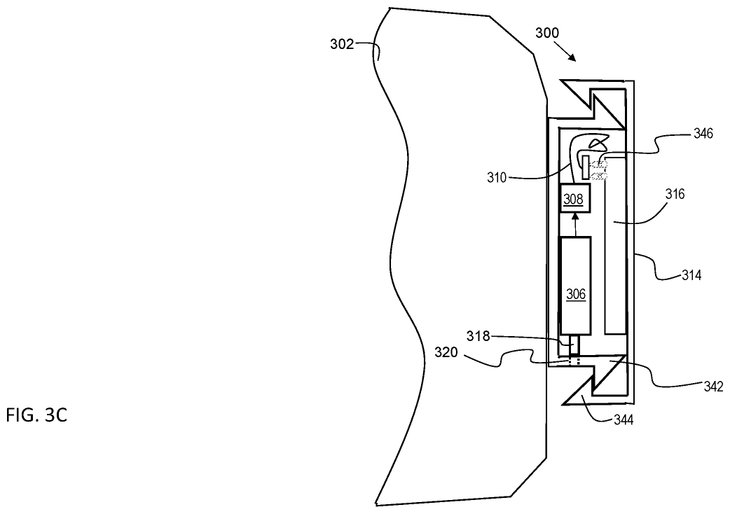

FIG. 3A shows an example of a self-contained electroluminescent vehicle ornament 300 in accordance with embodiments of the present invention during the installation process. FIG. 3B shows an example of a self-contained electroluminescent vehicle ornament in accordance with embodiments of the present invention in an installed configuration. FIG. 3C shows an example of a self-contained electroluminescent vehicle ornament in accordance with embodiments of the present invention in a recharging configuration. The self-contained electroluminescent vehicle ornament can include its own rechargeable battery 306, and AC inverter 308. This enables the self-contained electroluminescent vehicle ornament to be installed easily, without the need to access the electrical power source of the vehicle. Thus, the self-contained electroluminescent vehicle ornament is well-suited for aftermarket use.

The embodiment shown in FIG. 3A is a two-piece embodiment, that includes a mounting plate 304, that mates with an ornament cover 314. The mounting plate 304 may be affixed to a vehicle portion 302 via adhesive, screws, or other fastening mechanism. Vehicle portion 302 can be a fender, quarter-panel, door, trunk lid, roof, hood, grille, or other suitable vehicle portion. The mounting plate 304 may provide a power connection 318 for charging the rechargeable battery 306. In embodiments, the rechargeable battery 306 can include a Lithium-Ion battery, Nickel-Metal Hydride battery, Nickel-Cadmium battery, or other suitable battery type. In embodiments, the battery 306 outputs 12 volts DC (direct current).

In some embodiments, the power connection 318 comprises a USB-C port. A weather plug 322 may be inserted into the power connection 318 when not charging the battery 306. In embodiments, the weather plug 322 is comprised of rubber, silicone, or other suitable material. The weather plug 322 serves to prevent excess moisture from entering the power connection 318.

The battery 306 is coupled to an AC inverter 308. A wire 310 extends from the AC inverter 308 to a connector 312. In embodiments, the AC inverter 308 outputs alternating current at a frequency ranging from 380 Hertz to 420 Hertz. The connector 312 is configured to connect to terminal connector 346, which provides AC current to electroluminescence device 316. Electroluminescence device 316 may be similar to electroluminescence device 100 or electroluminescence device 180 previously described.

The mounting plate 304 comprises a set of tabs, indicated as 342, that engage with a corresponding set of tabs on the cover 314. The tabs on the cover are indicated as 344. To install the self-contained electroluminescent vehicle ornament 300 on a vehicle, the mounting plate 304 is affixed to the vehicle via adhesive, screws, or other suitable fastening mechanism. The connector 312 is attached to terminal connector 346, and the cover 314 is pressed onto the mounting plate 304 such that tabs 344 engage with tabs 342, as shown in FIG. 3B. When it is necessary to recharge the battery 306, the weather plug 322 is removed, as shown in FIG. 3C, to allow a charging cable (not shown) to be plugged into the power connection 318, via access opening 320. Once charging is complete, the weather plug 322 can be reinstalled to seal the access opening 320, such as is depicted in FIG. 3B.

Embodiments can include a rechargeable battery; a charging port, coupled to the rechargeable battery; an alternating current (AC) inverter, configured and disposed to receive direct current from the battery, and output alternating current to the electroluminescence device; a housing, the housing configured and disposed to contain the electroluminescence device, and the rechargeable battery, and wherein the housing comprises a translucent portion that is aligned with the electroluminescence device.

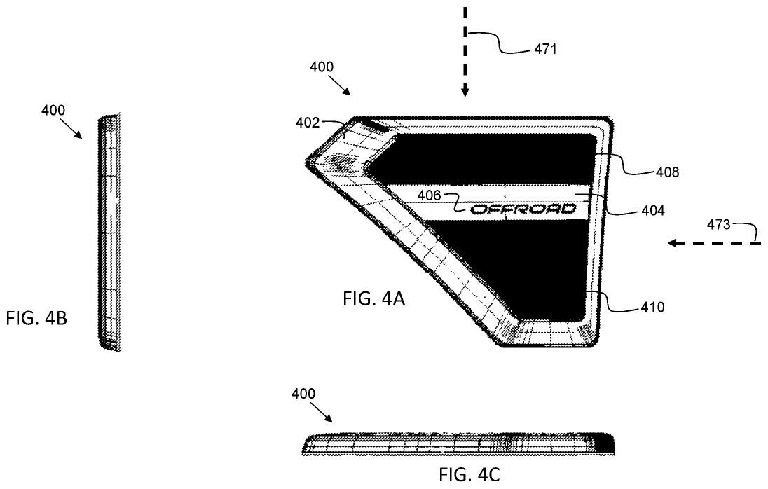

FIG. 4A-4C show an example of an electroluminescent vehicle ornament 400 in accordance with embodiments of the present invention. FIG. 4A shows an example of a front view of an electroluminescent vehicle ornament in accordance with embodiments of the present invention. FIG. 4B shows a side view of the electroluminescent vehicle ornament of FIG. 4A as viewed from the direction of arrow 473 of FIG. 4A. FIG. 4C shows a top-down view of the electroluminescent vehicle ornament of FIG. 4A as viewed from the direction of arrow 471 of FIG. 4A. Electroluminescent vehicle ornament 400 can be implemented as a self-contained electroluminescent vehicle ornament such as shown in FIG. 3B, or can be connected to a vehicle power supply such as shown in the embodiment of FIG. 2A and/or FIG. 2B.

Electroluminescent vehicle ornament 400 includes an outer bezel 402 that comprises translucent chrome. Two opaque areas 408 and 410 flank a horizontal translucent chrome section 404. The horizontal translucent chrome section 404 may optionally include opaque indicia 406 such as lettering and/or symbols. In this way, in twilight or nighttime conditions, the indicia 406 is clearly visible to observers when the electroluminescence device is activated.

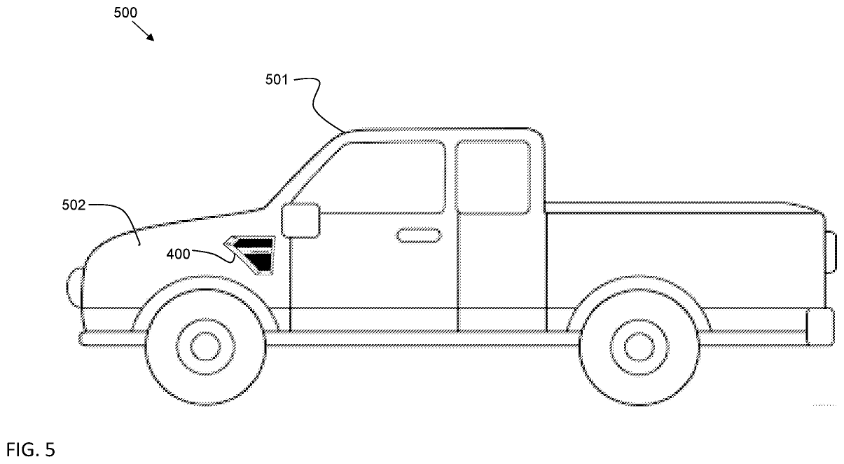

FIG. 5 shows an example 500 of the electroluminescent vehicle ornament of FIG. 4A attached to a vehicle 501. As shown in FIG. 5, the electroluminescent vehicle ornament 400 is attached to a fender 502 of the vehicle 501.

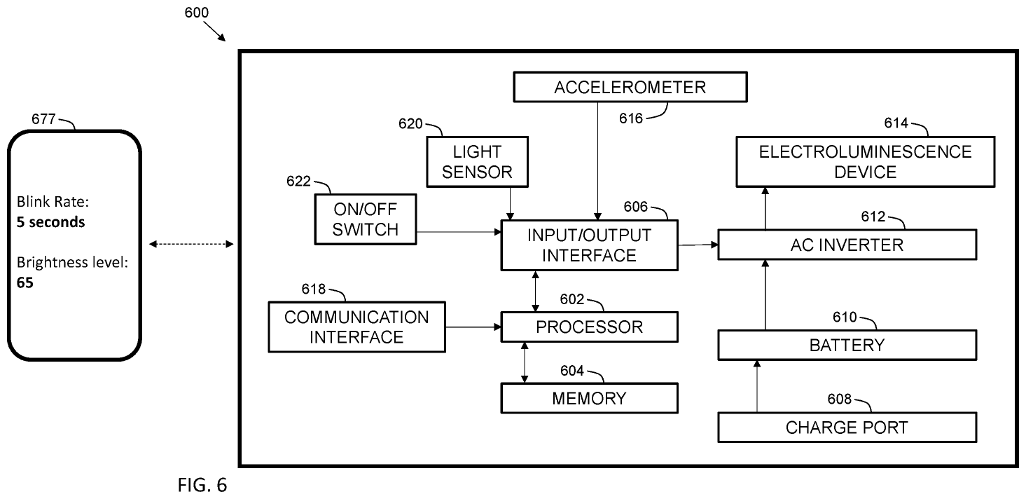

FIG. 6 is a block diagram showing components that can be included in an electroluminescent vehicle ornament 600 of disclosed embodiments. Embodiments include an electroluminescence device 614. Electroluminescence device 614 may be similar to electroluminescence device 100 or 180 as previously described. Electroluminescent vehicle ornaments of disclosed embodiments may further include an integrated alternating current (AC) inverter 612 that is coupled to a battery 610. The battery 610 may be a rechargeable battery. In some embodiments, a charge port 608 may be included, to allow charging of the battery while the battery remains in the electroluminescent vehicle ornament.

Embodiments may optionally include a processor 602, that is coupled to a computer memory 604. The computer memory may include a non-transitory computer readable medium, such as static random-access memory (SRAM), flash memory, or the like. The processor may be coupled to an input/output interface 606 that provides a plurality of general purpose I/O (GPIO) pins for interfacing with various peripherals. The peripherals can include, but are not limited to, an on/off switch 622, an ambient light sensor 620, an accelerometer 616, and/or a communication interface 618. The processor 602 can execute instructions stored in memory 604 in order to implement functions of disclosed embodiments. In some embodiments, the ambient light sensor 620 may be configured and disposed to put the processor 602 in a low-power mode, which can include operating the processor at a reduced frequency to conserve additional power. The low-power mode may also disable communication interface 610 to further save power during levels of ample ambient light.

The on/off switch 622 can be used to conserve energy stored in battery 610, for situations such as when the vehicle is not in use, or during daylight conditions. Embodiments may further include an ambient light sensor 620. In embodiments, the ambient light sensor 620 comprises a photoelectric cell that provides a signal to I/O interface 606 that is proportional to the amount of ambient light. In some embodiments, the processor processes the signal from the ambient light sensor 620 to define three ranges of ambient light: daylight, twilight, and darkness.

In embodiments, daylight is defined as a light level of 1000 Lux or greater, twilight is defined as a light level ranging from 20 Lux up to 1000 Lux, and darkness is a light level of less than 20 Lux. Some embodiments may utilize different limits for daylight, twilight, and darkness. Some embodiments may include additional ranges, such as bright daylight, overcast, and the like.

Disclosed embodiments can perform different modes of operation based on the ambient light range. As an example, during a daylight range, the electroluminescence device 614 can be deactivated to conserve power. During a twilight range, the electroluminescence device 614 can be activated to a first brightness level, and during a darkness range, the electroluminescence device 614 can be activated to a second brightness level. In embodiments, the first brightness level is brighter than the second brightness level. In the twilight range, the brightness level may be set to a maximum brightness level. This can serve to create a visible optical effect while there is still a considerable amount of ambient light. When the ambient light level is in the darkness range, embodiments can switch to the second brightness level, which may be a reduced brightness level, in the range of 50 percent to 60 percent of the maximum level. This saves power, while still providing a visible optical effect. With less ambient light, less electroluminescent light from electroluminescence device 614 is needed. The brightness level is a measure of how much light is being emitted from the electroluminescence device.

The accelerometer 616 may be present in some embodiments. In embodiments, the accelerometer 616 provides a signal to I/O interface 606 that is proportional to the amount of acceleration of the vehicle. In some embodiments, the processor processes the signal from the accelerometer 616 to define an acceleration mode, and a static mode. The acceleration mode is active when the accelerometer detects acceleration above a predetermined threshold. The static mode is active when the detected acceleration is at or below the predetermined threshold. In embodiments, the electroluminescence device 614 can be activated to a first brightness level in the acceleration mode, and a second brightness level in the static mode. In some embodiments, the first brightness level is brighter than the second brightness level. This can create an interesting visual effect, such as, for example, a vehicle ornament that gets brighter as the vehicle transitions to moving from being stopped.

The communication interface 618 may be present in some embodiments. The communication interface 618 can include a wireless communication interface. In some embodiments, the communication interface 618 can include a Bluetooth interface. The Bluetooth interface can be configured to communicate with a remote electronic computing device 677. Remote electronic computing device 677 can include a tablet computer, smartphone, smart watch, wearable computer, vehicle infotainment system, and/or other suitable remote electronic computing device. The remote electronic computing device may provide additional user interface functions, such as setting a blink rate, brightness level, color control, and the like. In some embodiments, the electroluminescent vehicle ornament may include multiple regions (e.g., upper and lower), with each region having its own corresponding electroluminescence device that can be controlled individually, giving an improved level of customization for electroluminescent vehicle ornaments of disclosed embodiments. Embodiments can include a communication interface, and in some embodiments, the communication interface receives an activation message, and activates the electroluminescence device in response to the message. The activation message can be received from the remote electronic computing device 677.

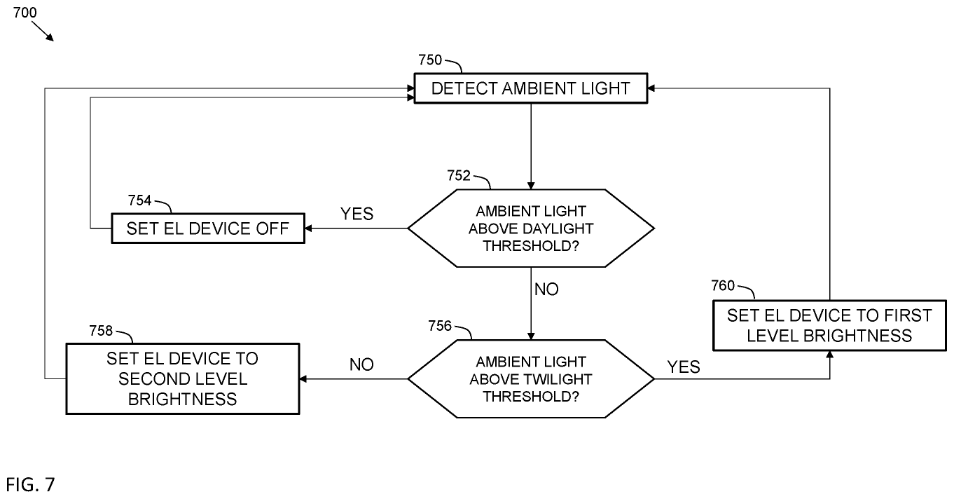

FIG. 7 is a flowchart 700 indicating process steps for embodiments of the present invention. At 750, ambient light is detected. At 752, a check is made to determine if the ambient light is above the daylight threshold (e.g., 1000 Lux). If yes, then the electroluminescence (EL) device is shut off at 754, and the process continues back to 750 where ambient light is periodically/continuously monitored. If no at 752, then the process continues to 756 where a check is made to determine if the ambient light is above the twilight threshold (e.g., 20 Lux). If yes at 756, then the electroluminescence (EL) device is set to a first brightness level at 760, and the process continues back to 750 where ambient light is periodically/continuously monitored. If no at 756, then the electroluminescence (EL) device is set to a second brightness level at 758, and the process continues back to 750 where ambient light is periodically/continuously monitored. In this way, battery power can be conserved while still providing optimal light level for a variety of ambient light conditions.

In embodiments, the memory contains instructions, that when executed by the processor, cause the processor to: set the electroluminescence device to a first brightness level in response to ambient light falling below a daylight level and wherein the ambient light is also above a twilight level; and set the electroluminescence device to a second brightness level when the ambient light falls below a twilight level. In embodiments, the first brightness level is brighter than the second brightness level. Embodiments can further include an accelerometer coupled to the processor. In embodiments, brightness of the electroluminescence device varies as a function of acceleration of a vehicle to which the electroluminescent vehicle ornament is attached. In embodiments, the brightness increases with increasing acceleration of the vehicle.

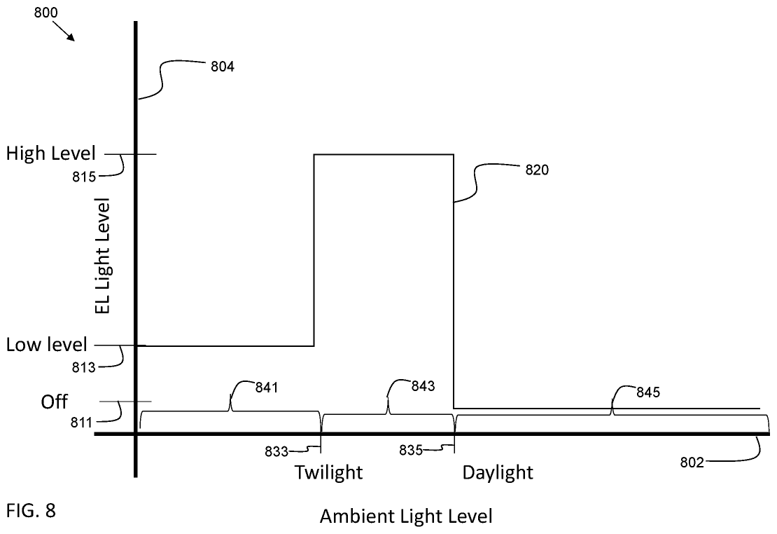

FIG. 8 shows an electroluminescent response graph 800 for embodiments of the present invention. Graph 800 includes a horizontal axis 802 that represents ambient light level. Two specific points are indicated on the horizontal axis 802: the twilight threshold 833, and the daylight threshold 835.

Graph 800 includes a vertical axis 804 that represents an electroluminescence device level. Three specific points are indicated on the vertical axis 804: the off level 811 (the electroluminescence device is not outputting light), the low level 813 (the electroluminescence device is outputting a reduced light level that is less than the maximum output), and the high level 815 where the electroluminescence device is outputting the maximum light output.

As can be seen by the graph curve 820, the electroluminescence device operates at a low level when the ambient light is below the twilight threshold 833. The electroluminescence device operates at a high level when the ambient light is above the twilight threshold 833 and below the daylight threshold 835. The electroluminescence device deactivates (off level) when the ambient light is above the daylight threshold 835. Thus, the twilight threshold 833 and daylight threshold 835 create three regions that can correspond to three modes of operation in some embodiments. Region 841 represents a darkness mode (e.g., nighttime). Region 843 represents a twilight mode (e.g., dawn, dusk). Region 845 represents a daytime mode. In embodiments, each mode has a corresponding electroluminescence device output pattern and/or level. The pattern can include blinking, and/or color changing.

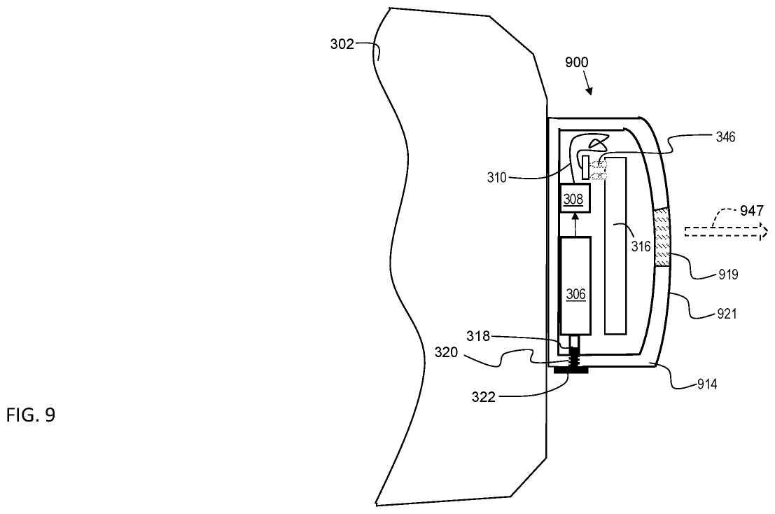

FIG. 9 shows an example of a self-contained electroluminescent vehicle ornament 900 in accordance with another embodiment of the present invention. Electroluminescent vehicle ornament 900 may comprise internal components that are similar to electroluminescent vehicle ornament 300 described previously, with a key difference being a one-piece enclosure 914 that is affixed to the vehicle portion 302 via adhesive, or other suitable mechanism. The enclosure 914 may include a translucent portion 919, and an opaque region, indicated generally as 921. The translucent portion 919 can be a translucent chrome portion, a transparent portion, a tinted transparent/translucent portion, a translucent gold portion, or other suitable translucent portion. The translucent portion 919 can be aligned with the electroluminescence device 316, such that light produced by the electroluminescence device 316 can pass through the translucent portion 919, indicated by arrow 947.

As can now be appreciated disclosed embodiments provide an electroluminescent vehicle ornament that provides advanced features and ease of installation. Disclosed embodiments are well-suited for aftermarket use to provide customization for vehicles. Embodiments can also be used in a factory-installed environment during the time of manufacture of a vehicle. Disclosed embodiments can function has hood ornaments, trunk ornaments, vehicle badges mounted on the sides of a vehicle, mounted on wheel hubs, door handles, A-pillar, B-pillar, C-pillar, and/or other suitable locations. Disclosed embodiments can be used on motorcycles, bicycles, snowmobiles, all-terrain vehicles (ATVs), boats, scooters, and/or other vehicles, enabling exciting visual effects that can be used to promote vehicle branding and customization. Disclosed embodiments interface with sensors such as light sensors and/or accelerometers to provide dynamic effects as the mode of operation is changed based on environmental conditions such as ambient light and/or vehicle acceleration. The dynamic effects can include, but are not limited to, changing the intensity of light output from the electroluminescent vehicle ornament, changing a blink pattern, changing a color output, syncing a blink pattern and/or color output change to music, and/or other dynamic effects.

Unless otherwise described herein, components of disclosed embodiments are made from plastic, glass, composite, metal, rubber, silicone, or any other suitable material, now known or hereafter developed.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed is:

1. An electroluminescent vehicle ornament, comprising:
an electroluminescence device, the device comprising:
a transparent conductive-coated substrate;
a first electrode disposed on a first portion of the transparent conductive-coated substrate;
an electroluminescent layer disposed on a second portion of the transparent conductive-coated substrate;
a reflecting dielectric layer disposed on the electroluminescent layer;
a second electrode disposed on the reflecting dielectric layer; and
a housing, wherein the housing is configured and disposed to contain the electroluminescence device, and wherein the housing comprises a translucent portion that is aligned with the electroluminescence device.

2. The electroluminescent vehicle ornament of claim 1, wherein the translucent portion of the housing comprises translucent chrome.

3. The electroluminescent vehicle ornament of claim 2, further comprising a plurality of triangular grooves formed in the translucent portion.

4. The electroluminescent vehicle ornament of claim 1, wherein the reflecting dielectric layer comprises silicon dioxide.

5. The electroluminescent vehicle ornament of claim 1, wherein the reflecting dielectric layer comprises titanium dioxide.

6. An electroluminescent vehicle ornament, comprising:
an electroluminescence device, the device comprising:
a transparent conductive-coated substrate;
a first electrode disposed on a first portion of the transparent conductive-coated substrate;
an electroluminescent layer disposed on a second portion of the transparent conductive-coated substrate;
a reflecting dielectric layer disposed on the electroluminescent layer;
a second electrode disposed on the reflecting dielectric layer; and
a rechargeable battery;
a charging port, coupled to the rechargeable battery;
an alternating current (AC) inverter, configured and disposed to receive direct current from the rechargeable battery, and output alternating current to the electroluminescence device;
a housing, the housing configured and disposed to contain the electroluminescence device, and the rechargeable battery, and wherein the housing comprises a translucent portion that is aligned with the electroluminescence device.

7. The electroluminescent vehicle ornament of claim 6, wherein the translucent portion of the housing comprises translucent chrome.

8. The electroluminescent vehicle ornament of claim 7, further comprising a plurality of triangular grooves formed in the translucent portion.

9. The electroluminescent vehicle ornament of claim 6, wherein the reflecting dielectric layer comprises silicon dioxide.

10. The electroluminescent vehicle ornament of claim 6, wherein the reflecting dielectric layer comprises titanium dioxide.

11. An electroluminescent vehicle ornament, comprising:
an electroluminescence device, the device comprising:
a transparent conductive-coated substrate;
a first electrode disposed on a first portion of the transparent conductive-coated substrate;
an electroluminescent layer disposed on a second portion of the transparent conductive-coated substrate;
a reflecting dielectric layer disposed on the electroluminescent layer;
a second electrode disposed on the reflecting dielectric layer; and
a rechargeable battery;
a charging port, coupled to the rechargeable battery;
an alternating current (AC) inverter, configured and disposed to receive direct current from the rechargeable battery, and output alternating current to the electroluminescence device;
a processor;
a memory coupled to the processor;
an ambient light sensor coupled to the processor;
a housing, the housing configured and disposed to contain the electroluminescence device, processor, memory, ambient light sensor, and the rechargeable battery, and wherein the housing comprises a translucent portion that is aligned with the electroluminescence device.

12. The electroluminescent vehicle ornament of claim 11, wherein the translucent portion of the housing comprises translucent chrome.

13. The electroluminescent vehicle ornament of claim 12, further comprising a plurality of triangular grooves formed in the translucent portion.

14. The electroluminescent vehicle ornament of claim 11, wherein the memory contains instructions, that when executed by the processor, cause the processor to:
set the electroluminescence device to a first brightness level in response to ambient light falling below a daylight level and wherein the ambient light is also above a twilight level; and
set the electroluminescence device to a second brightness level when the ambient light falls below a twilight level.

15. The electroluminescent vehicle ornament of claim 14, wherein the first brightness level is brighter than the second brightness level.

16. The electroluminescent vehicle ornament of claim 11, further comprising an accelerometer coupled to the processor.

17. The electroluminescent vehicle ornament of claim 16, wherein brightness of the electroluminescence device varies as a function of acceleration of a vehicle to which the electroluminescent vehicle ornament is attached.

18. The electroluminescent vehicle ornament of claim 17, wherein the brightness increases with increasing acceleration of the vehicle.

19. The electroluminescent vehicle ornament of claim 11, further comprising a communication interface, and wherein the communication interface receives an activation message, and activates the electroluminescence device in response to the message.

20. The electroluminescent vehicle ornament of claim 19, wherein the communication interface includes a Bluetooth interface.
